(19) United States
(12) Patent Application Publication
(10) Pub. No.: US 2010/0261080 A1
(43) Pub. Date: Oct. 14, 2010

(54) FUEL CELL SYSTEM AND METHOD OF CONTROLLING STARTUP OF FUEL CELL SYSTEM

(75) Inventor: Naoki Kanie, Toyota-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/740,557

(22) PCT Filed: Oct. 20, 2008
(86) PCT No.: PCT/JP2008/069384

§ 371 Date: Apr. 29, 2010

(30) Foreign Application Priority Data
Oct. 30, 2007 (JP) 2007-281930

(51) Int. Cl. H01M 8/04

(52) U.S. Cl. 429/429

(57) ABSTRACT

At startup of the fuel cell system, following successful completion of feeding of reactant gases (a fuel gas and an oxidant gas) to the fuel cell, the open circuit voltage OCV of the fuel cell is measured, and based on whether the open circuit voltage of the fuel cell is equal to or greater than a prescribed voltage OCVth, it is decided whether the fuel cell is experiencing a generation malfunction. The decision as to whether feeding of the reactant gases to the fuel cell has successfully completed will be made, for example, on the basis of whether feed pressure of the reactant gases to the fuel cell is at or above prescribed pressure. Thus, generation malfunction in the fuel cell can be correctly diagnosed at startup of the fuel cell system.

### TECHNICAL FIELD

The present invention relates to a fuel cell system and to a method of controlling startup of the fuel cell system.

### BACKGROUND ART

Fuel cells, which generate electricity through an electrochemical reaction of a fuel gas (e.g. hydrogen) and an oxidant gas (e.g. oxygen), have attracted notice as energy sources. In a fuel cell system equipped with such a fuel cell, during startup of the fuel cell system it is typical practice, while supplying the reactant gases for power generation (namely, fuel gas and oxidant gas) to the fuel cell, to also measure the open circuit voltage of the fuel cell in order to determine whether the fuel cell has reached a condition permitting connection to a load, that is, whether the open circuit voltage of the fuel cell has risen to a prescribed voltage (see for example JP-A 2005-302539).

However, with the fuel cell system disclosed in above-cited JP-A 2005-302539, despite the fact that measurement of open circuit voltage of the fuel cell is performed and a determination is made as to whether the fuel cell is connectable to a load, no attempt is made to determine or decide conclusively on the basis of this measured open circuit voltage of the fuel cell whether a generation malfunction of the fuel cell has occurred. For this reason, even if a generation malfunction has occurred, the fuel cell cannot be controlled in failsafe mode.

### DISCLOSURE OF THE INVENTION

In view of the problem discussed above, it is an object of the present invention to provide a fuel cell system adapted to reliably determine if generation malfunction has occurred in a fuel cell, during startup of the fuel cell system.

The above objects of this invention may be attained at least in part according to at the following aspects and modes of the invention.

[First Mode] A fuel cell system comprising:

a fuel cell;

a reactant gas feed portion for supplying the fuel cell with reactant gases for power generation;

a reactant gas successful feed decision portion that at startup of the fuel cell system decides whether feed of the reactant gases to the fuel cell by the reactant gas feed portion was successfully completed; and

a generation malfunction diagnosis portion that, subsequent to a decision by the reactant gas successful feed decision portion that feeding of the reactant gases was successfully completed, determines whether the fuel cell is experiencing a generation malfunction, based on an open circuit voltage of the fuel cell.

According to the fuel cell system of the first mode, after successfully feeding the reactant gases to the fuel cell, the open circuit voltage of the fuel cell is measured, and based on the measured open circuit voltage it is determined whether the fuel cell is experiencing a generation malfunction. Accordingly, a generation malfunction in the fuel cell can be correctly diagnosed at startup of the fuel cell system. Open circuit voltage of the fuel cell is measured after successful feeding of reactant gases to the fuel cell. Accordingly, it is possible to distinguish between an instance in which open circuit voltage of the fuel cell has failed to rise to prescribed voltage due to a malfunction in the reactant gas feed portion (reactant gas feed system) versus an instance in which open circuit voltage of the fuel cell has failed to rise to prescribed voltage due to a malfunction in the fuel cell itself, and thus to correctly diagnose a generation malfunction occurring in the fuel cell. Once a generation malfunction in the fuel cell has been diagnosed, control can then be carried out in failsafe mode.

[Second Mode] The fuel cell system according to the first mode wherein

in the event that the open circuit voltage fails to reach prescribed voltage within a first prescribed time interval following the decision by the reactant gas successful feed decision portion that feed of the reactant gases to the fuel cell was successful, the generation malfunction diagnosis portion determines that generation malfunction has occurred in the fuel cell.

According to the fuel cell system of the second mode, the diagnosis that a generation malfunction has occurred in the fuel cell is made in the event that the open circuit voltage of the fuel cell fails to reach prescribed voltage within a first prescribed time interval following the decision that feed of the reactant gases to the fuel cell was successful. Accordingly, instances of misdiagnosis of generation malfunction can be avoided. This first time interval may be established arbitrarily, within a predicted range for open circuit voltage of the fuel cell to reach prescribed voltage in the absence of generation malfunction in the fuel cell.

[Third Mode] The fuel cell system according to the first or second mode further comprising

a pressure sensor adapted to sense pressure of the reactant gases supplied to the fuel cell,

wherein the reactant gas successful feed decision portion makes the decision regarding whether the feed of the reactant gases to the fuel cell was successfully completed, based on pressure of the reactant gases sensed by the pressure sensor.

According to the fuel cell system of the third mode, by sensing the pressure of the reactant gases supplied to the fuel cell, it can be determined whether the reactant gas feed portion is experiencing a malfunction (reactant gas feed system).

[Fourth Mode] The fuel cell system according to the third mode wherein

in the event that pressure of the reactant gases fails to reach prescribed pressure within a second prescribed time interval following initiation of feed of the reaction gases to the fuel cell by the reactant gas feed portion, the reactant gas successful feed decision portion further decides that the reactant gas feed portion is experiencing a malfunction.

According to the fuel cell system of the fourth mode, the diagnosis of a malfunction of the reactant gas feed portion (reactant gas feed system) will be made in the event that pressure of a reactant gas fails to reach prescribed pressure within a second prescribed time interval following initiation of feed of the reaction gas to the fuel cell. Accordingly, instances of misdiagnosed malfunction of the reactant gas feed portion can be avoided. This second time interval may be established arbitrarily within a predicted range for pressure of the reactant gases to reach prescribed pressure in the absence of a malfunction of the reactant gas feed portion.

[Fifth Mode] The fuel cell system according to the first or second mode further comprising

a flow rate sensor adapted to sense flow rate of the reactant gases being delivered to the fuel cell,

wherein the reactant gas successful feed decision portion makes the decision regarding whether the feed of the reactant gases to the fuel cell was successfully completed, based on flow rate of the reactant gases sensed by the flow rate sensor.

According to the fuel cell system of the fifth mode, by sensing the flow rate of reactant gases delivered to the fuel cell, it can be decided whether a malfunction of the reactant gas feed portion has occurred.

[Sixth Mode] The fuel cell system according to the fifth mode wherein

in the event that flow rate of the reactant gases fails to reach a prescribed flow rate within a second prescribed time interval following initiation of feed of the reaction gases to the fuel cell by the reactant gas feed portion, the reactant gas successful feed decision portion further decides that the reactant gas feed portion is experiencing a malfunction.

According to the fuel cell system of the sixth mode, the diagnosis that a malfunction of the reactant gas feed portion (reactant gas feed system) has occurred will be made in the event that flow rate of a reactant gas fails to reach a prescribed flow rate within a second prescribed time interval following initiation of feed of the reaction gases to the fuel cell. Accordingly, instances of misdiagnosis of malfunction of the reactant gas feed portion can be avoided. This second time interval may be established arbitrarily within a predicted range for the flow rate of reactant gases to reach prescribed flow rates in the absence of a malfunction of the reactant gas feed portion.

[Seventh Mode] The fuel cell system according to the fourth or sixth mode wherein

in the event of a decision by the reactant gas successful feed decision portion that the reactant gas feed portion is experiencing a malfunction, the generation malfunction diagnosis portion disables carrying out of the determination as to whether the fuel cell is experiencing the generation malfunction.

According to the fuel cell system of the seventh mode, in the event of a diagnosis of malfunction of the reactant gas feed portion (reactant gas feed system), diagnosis of generation malfunction of the fuel cell will be disabled and measurement of open circuit voltage of the fuel cell will not take place. Accordingly, control in failsafe mode can be carried out without delay.

The present invention may be constituted using any number of appropriate combinations of the technical elements described above. Besides being constituted as the fuel cell system described above, the present invention could be constituted as an invention of a method for controlling startup of a fuel cell system. Additional possible modes could include a computer program for implementing these; a recording medium having such a program recorded thereon; or a data signal containing such a program and carried on a carrier wave. These respective modes may employ the various supplemental elements shown previously.

Where the present invention is constituted as a computer program or recording medium having the program recorded thereon, it may constitute the entire program for controlling operation of the fuel cell system, or constitute only those modules which perform the functions of the present invention. Possible recording media include any of various computer-readable media such as flexible disks, CD-ROM, DVD-ROM, magnetooptical disks, IC cards, ROM cartridges, punch cards, printed materials having symbols such as barcodes imprinted thereon, computer internal storage devices (memory such as RAM or ROM), and external storage devices.

### BRIEF DESCRIPTION OF THE DRAWINGS

FIG. 1 is an illustration depicting in overview the configuration of a fuel cell system 1000 furnished with a fuel cell stack 100 in an embodiment of the present invention;

FIG. 2 is an illustration depicting function blocks in a control unit 90 for executing the startup control process of Embodiment 1;

FIG. 3 is a flowchart depicting the flow of the startup control process of Embodiment 1;

FIG. 4 is an illustration depicting function blocks in a control unit 90A for executing the startup control process of Embodiment 2; and

FIG. 5 is a flowchart depicting the flow of the startup control process of Embodiment 2.

### BEST MODE FOR CARRYING OUT THE INVENTION

The modes of the invention will be described below based on specific embodiments, in the following order.

### A. Embodiment 1

### A1. Configuration of Fuel Cell System

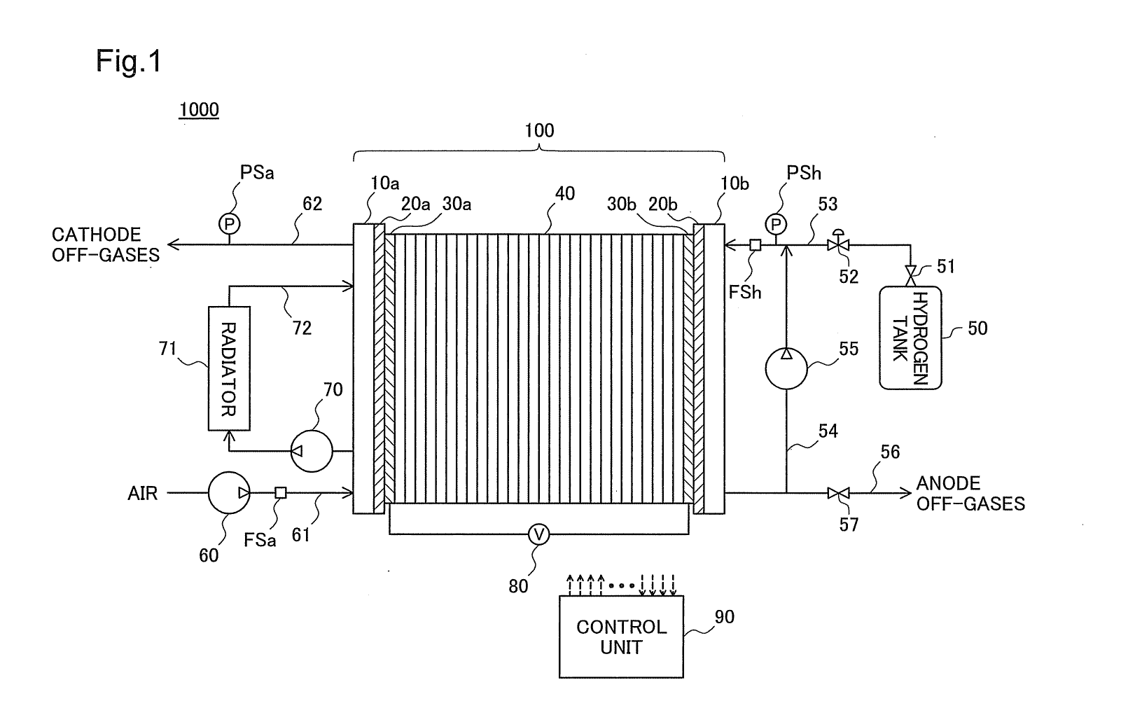

FIG. 1 is an illustration depicting in overview the configuration of a fuel cell system 1000 furnished with a fuel cell stack 100 in an embodiment of the present invention.

The fuel cell stack 100 has a stacked structure composed of a plural number of stacked fuel cell modules 40 that are designed to generate electricity through an electrochemical reaction of hydrogen and oxygen. Each fuel cell module 40 is generally furnished with a membrane-electrode assembly which is composed of an anode and a cathode respectively joined to either side of a proton-conductive electrolyte membrane, and which is sandwiched between separators. The anode and the cathode are respectively provided with a catalyst layer which is joined to the corresponding surface of the electrolyte membrane, and with a gas diffusion layer which is joined to the surface of this catalyst layer. In the present embodiment, a solid polymer membrane of NAFION™ or the like is used as the electrolyte membrane. Other electrolyte membranes, such as solid oxides, could also be used as the electrolyte membrane. In each separator there are formed channels for the hydrogen which is to be supplied as fuel gas to the anode, channels for the air which is to be supplied as oxidant gas to the cathode, and channels for a coolant. The number of stacked fuel cell modules 40 may be established freely, depending on the output required of the fuel cell stack 100.

The fuel cell stack 100 is composed, in order from a first end, of an end plate 10a, an insulator plate 20a, a collector plate 30a, a plurality of fuel cell modules 40, a collector plate 30b, an insulator plate 20b, and an end plate 10b in that order. These are provided inside the fuel cell stack 100 with feed openings and discharge openings for the hydrogen, air, and coolant flows. Inside the fuel cell stack 100 there are also formed feed manifolds for distributing the hydrogen, air, and coolant feeds to the respective fuel cell modules 40 (namely, a hydrogen feed manifold, an air feed manifold, and a coolant feed manifold); and discharge manifolds for collecting and discharging to the outside of the fuel cell stack 100 the anode off-gases and cathode off-gases which have been respectively discharged from the anode and cathode of the fuel cell modules 40, and the coolant (namely, an anode off-gas discharge manifold, a cathode off-gas discharge manifold, and a coolant discharge manifold).

The end plates 10a, 10b are made of metal such as steel, in order to ensure rigidity. The insulator plates 20a, 20b are made of insulating members such as rubber or resin. The collector plates 30a, 30b are made of gas-impermeable, electrically conductive members such as dense carbon or copper plates. The collector plates 30a, 30b are respectively furnished with output terminals (not shown), and are adapted to output power generated by the fuel cell stack 100. A voltmeter 80 for measuring open circuit voltage of the fuel cell stack 100 is connected to the collector plates 30a, 30b.

While not illustrated in the drawings, the fuel cell stack 100 is fastened together by fastening members which apply prescribed fastening load in the stacking direction of the stack structure, in order to limit drop in cell capabilities due inter alia to increased contact resistance at any location in the stack structure, and in order to limit leakage of gases.

The anodes of the fuel cell stack 100 are supplied with hydrogen fuel gas fed via a hydrogen feed line 53 from a hydrogen tank 50 storing high-pressure hydrogen. In place of the hydrogen tank 50, hydrogen-rich gas could be generated by a reforming reaction of feedstock such as alcohols, hydrocarbons, or aldehydes, and the gas then supplied to the anodes. On the hydrogen feed line 53 there are also disposed a pressure sensor PSh adapted to sense the pressure of the hydrogen fed to the fuel cell stack 100, and a flow rate sensor FSh adapted to sense the flow rate of the hydrogen fed to the fuel cell stack 100.

The high-pressure hydrogen stored in the hydrogen tank 50, having undergone regulation of its pressure and feed rate by a stop valve 51 and a regulator 52 disposed at the outlet of the hydrogen tank 50, is supplied via the hydrogen feed manifold to the anodes of the fuel cell modules 40. The anode off-gases discharged from the fuel cell modules 40 can be discharged to the outside of the fuel cell stack 100 via a discharge line 56 that is connected to the anode off-gas discharge manifold. During discharge of the anode off-gases out from the fuel cell stack 100, hydrogen contained in the anode off-gases will be treated by a dilution unit, not shown.

The hydrogen feed line 53 and the discharge line 56 are connected to a recirculation line 54 for recirculating anode off-gases to the hydrogen feed line 53. An exhaust valve 57 is disposed downstream from the junction of the discharge line 56 with the recirculation line 54. A pump 55 is disposed on the recirculation line 54. By controlling actuation of the pump 55 and the exhaust valve 57, it is possible to switch appropriately between venting the anode off-gases to the outside or recirculating them to the hydrogen feed line 53. By recirculating anode off-gases to the hydrogen feed line 53, unconsumed hydrogen contained in the anode off-gases can be utilized efficiently.

The cathodes of the fuel cell stack 100 are supplied via an air feed line 61 with compressed air that has been compressed by an air compressor 60, by way of the oxidant gas containing oxygen. This compressed air is then supplied to the cathodes of the fuel cell modules 40 via the air feed manifold which is connected to the air feed line 61. The cathode off-gases that were discharged from the cathodes of the fuel cell modules 40 are vented to the outside of the fuel cell stack 100 via a discharge line 62 that is connected to the cathode off-gas discharge manifold. The discharge line 62 vents not only the cathode off-gases, but also evolved water that has evolved at the cathodes of the fuel cell stack 100 through the electrochemical reaction between hydrogen and oxygen. A flow rate sensor FSa adapted to sense the flow rate of air fed into the fuel cell stack 100 is disposed on the air feed line 61. A pressure sensor PSa adapted to indirectly sense the pressure of air feed into the fuel cell stack 100 is disposed on the discharge line 62.

Since the fuel cell stack 100 radiates heat due to the aforementioned electrochemical reaction, the fuel cell stack 100 is also supplied with a coolant for cooling the fuel cell stack 100. This coolant is circulated by a pump 70 through a line 72, and is cooled by a radiator 71 then supplied to the fuel cell stack 100.

Operation of the fuel cell system 1000 is controlled by a control unit 90. The control unit 90 is composed of a microcomputer having an internal CPU, RAM, ROM, a timer and so on, and is adapted to control operation of the system, for example, actuation of the various valves and pumps, in accordance with a program saved in ROM. The control unit 90 also executes a startup control program, discussed later, on the basis of the output of the pressure sensors PSh, PSa, the flow rate sensors FSh, FSa, and the voltmeter 80, when the fuel cell system is started up.

### A2. Control Unit

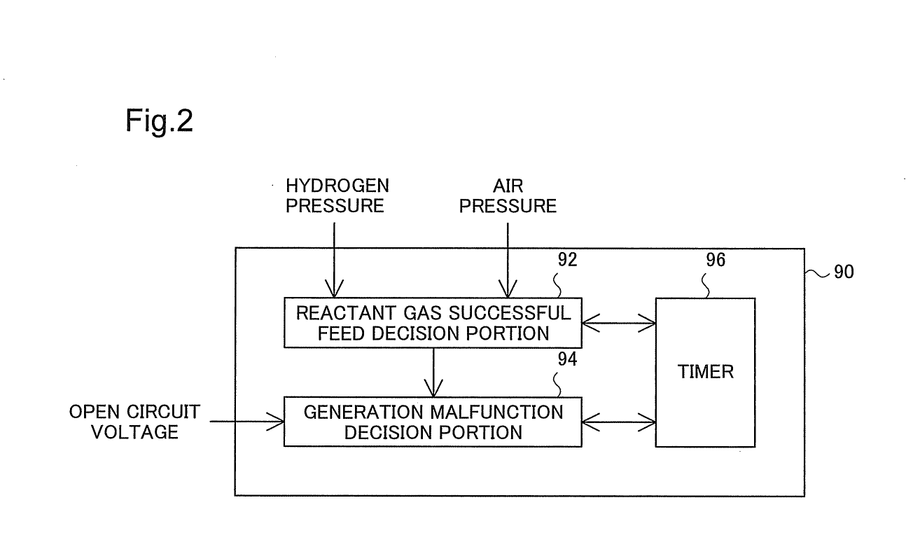

FIG. 2 is an illustration depicting function blocks in the control unit 90 for executing the startup control process of Embodiment 1. As illustrated, the control unit 90 is furnished with a reactant gas successful feed decision portion 92, a generation malfunction decision portion 94, and a timer 96.

On the basis of whether the pressure of hydrogen and the pressure of air supplied to the fuel cell stack 100 and respectively sensed by the pressure sensor PSh and the pressure sensor PSa have respectively reached prescribed pressure levels, the reactant gas successful feed decision portion 92 will decide whether hydrogen and air have been successfully fed to the fuel cell stack 100.

The generation malfunction decision portion 94 will determine whether the fuel cell is experiencing a generation malfunction stack 100, based on the open circuit voltage of the fuel cell stack 100 measured by the voltmeter 80.

As will be discussed later, the timer 96 measures elapsed time since initiation of feed of the reactant gases (hydrogen and air) to the fuel cell stack 100, as well as elapsed time since successful feeding of the reactant gases to the fuel cell stack 100 was accomplished. The startup control process of Embodiment 1 will be described in detail below.

### A3. Startup Control Process

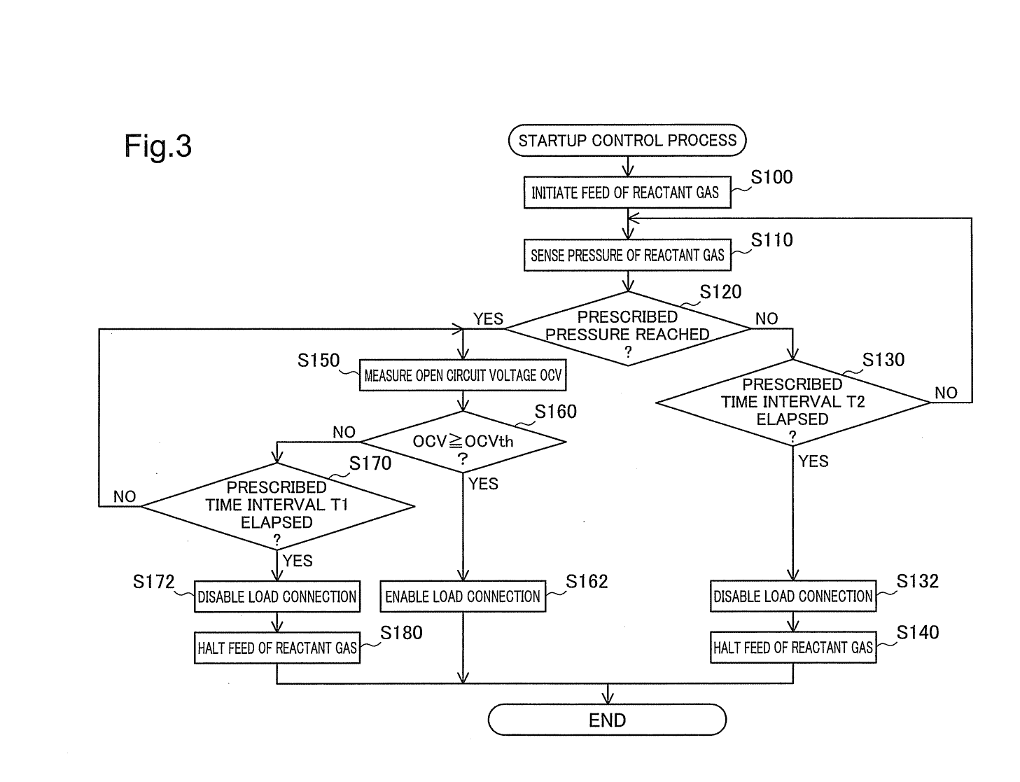

FIG. 3 is a flowchart depicting the flow of the startup control process of Embodiment 1. This process is one that is executed by the CPU of the control unit 90 when the fuel cell system 1000 is started up.

When a startup instruction is input to the fuel cell system 1000, the CPU will first control the valves and pumps, and initiate feed of the reactant gases (hydrogen and air) to the fuel cell stack 100 (Step S100). At this time, through the timer 96, the CPU will start measuring elapsed time since feed of the reactant gases to the fuel cell stack 100 was initiated.

Through the pressure sensors PSh, PSa, the CPU will then respectively sense the pressure of the hydrogen and the pressure of the air being supplied to the fuel cell stack 100 (Step S110), and through the reactant gas successful feed decision portion 92, will decide whether the pressure of the hydrogen and the pressure of the air have respectively reached prescribed pressure levels (Step S120). The prescribed pressure level for hydrogen and the prescribed pressure level for air have been established individually beforehand.

If at least one of the pressure of the hydrogen and the pressure of the air which are supplied to the fuel cell stack 100 has failed to reach its corresponding prescribed pressure level (Step S120: NO), the CPU will refer to the timer 96 through the reactant gas successful feed decision portion 92, and decide whether a prescribed time interval T2 has elapsed since feed of the reactant gases was initiated to the fuel cell stack 100 (Step S130). The time interval T2 may be established arbitrarily within a predicted range for pressure of the reactant gases to reach prescribed pressure levels absent any malfunction of the reactant gas feed system. This time interval T2 corresponds to the second time interval in the present invention. If the prescribed time interval T2 has not yet elapsed since feed of the reactant gases was initiated to the fuel cell stack 100 (Step S130: NO), the routine will return to Step S110.

On the other hand, if the prescribed time interval T2 has elapsed since feed of the reactant gases was initiated to the fuel cell stack 100 (Step S130: YES), the CPU will decide that a malfunction has occurred in a reactant gas feed system. Specifically, if hydrogen pressure has failed to reach prescribed pressure, the CPU will decide that there is a malfunction of the hydrogen feed system. If air pressure has failed to reach prescribed pressure, the CPU will decide that there is a malfunction of the air feed system. Then the CPU will prohibit connection of load to the fuel cell stack 100 (Step S132), as well as controlling the valves and pumps to halt the reactant gas feeds (Step S140). In this case, the CPU will also prohibit the determination as to whether there is generation malfunction of the fuel cell stack 100, described later. The CPU will then terminate the startup control process.

In Step S120, if the pressure of the hydrogen and the pressure of the oxygen being supplied to the fuel cell stack 100 have respectively reached their prescribed pressure levels (Step S120: YES), through the reactant gas successful feed decision portion 92 the CPU will decide that the reaction gases have been successfully fed to the fuel cell stack 100; and through the voltmeter 80 will measure the open circuit voltage OCV of the fuel cell stack 100 (Step S150), and acquire the value. At this time, the CPU will reset the timer 96 and begin measuring elapsed time starting from the point that feed of the reaction gases to the fuel cell stack 100 was successfully completed.

Then, through the generation malfunction decision portion 94, the CPU will decide whether the open circuit voltage OCV of the fuel cell stack 100 has reached a level equal to or greater than a prescribed voltage OCVth (Step S160). If the open circuit voltage OCV has reached a level equal to or greater than the prescribed voltage OCVth (Step S160: YES), the CPU will decide that there is no generation malfunction in the fuel cell stack 100, and will allow load to be connected the fuel cell stack 100 (Step S162). The CPU will then terminate the startup control process.

In Step S160, if the open circuit voltage OCV of the fuel cell stack 100 is less than the prescribed voltage OCVth (Step S160: NO), through the generation malfunction decision portion 94 the CPU will refer to the timer 96 and decide whether a prescribed time interval T1 has elapsed since feed of the reaction gases to the fuel cell stack 100 was successfully completed (Step S170). The prescribed time interval T1 may be established arbitrarily within a predicted range for open circuit voltage OCV of the fuel cell stack 100 to reach the prescribed voltage OCVth, given that there is no generation malfunction in the fuel cell stack 100. This prescribed time interval T1 corresponds to the first prescribed time interval in the present invention. If the prescribed time interval T1 has not yet elapsed since successful completion of feed of the reaction gases to the fuel cell stack 100 (Step S170: NO), the routine goes back to Step S150.

On the other hand, if the prescribed time interval T1 has elapsed since successful completion of feed of the reaction gases to the fuel cell stack 100 (Step S170), the CPU will decide that the fuel cell is experiencing a generation malfunction stack 100, and will prohibit load from being connected to the fuel cell stack 100 (Step S172), while controlling the valves and pumps to halt the feed of reactant gases (Step S140). The CPU will then terminate the startup control process.

According to the fuel cell system 1000 of Embodiment 1 described above, during the fuel cell system 1000 startup control process, once feed of the reaction gases to the fuel cell stack 100 has been successfully completed, the open circuit voltage OCV of the fuel cell stack 100 is measured, and on the basis of the measured open circuit voltage OCV, it is determined whether the fuel cell is experiencing a generation malfunction stack 100. Accordingly, a generation malfunction occurring in the fuel cell stack 100 can be at correctly diagnosed at startup of the fuel cell system 1000.

The open circuit voltage OCV of the fuel cell stack 100 is measured after completing successful feed of reactant gases to the fuel cell stack 100. Accordingly, it is possible to distinguish between an instance in which open circuit voltage OCV of the fuel cell stack 100 has failed to rise to the prescribed voltage OCVth due to a malfunction in the reactant gas feed system, versus an instance in which open circuit voltage OCV of the fuel cell stack 100 has failed to rise to the prescribed voltage OCVth due to a malfunction in the fuel cell stack 100 itself, and thus to correctly diagnose a generation malfunction occurring in the fuel cell stack 100. Once a generation malfunction in the fuel cell stack 100 has been diagnosed, control in failsafe mode (in the present embodiment, halting the feed of reactant gases) can then be carried out.

In the startup control process of Embodiment 1 described above, a diagnosis that a generation malfunction has occurred in the fuel cell stack 100 is made if the open circuit voltage OCV of the fuel cell stack 100 fails to reach the prescribed voltage OCVth within the prescribed time interval T1 following the decision that successful feed of reactant gases to the fuel cell stack 100 has been completed. Accordingly, instances of misdiagnosis of generation malfunction in the fuel cell stack 100 can be avoided.

In the startup control process of Embodiment 1 described above, a diagnosis that a malfunction of the reactant gas feed system has occurred will be made if the pressures of the reactant gases fail to reach their respective prescribed pressure levels within a second prescribed time interval T2 following initiation of feed of the reaction gas to the fuel cell stack 100. Accordingly, instances of misdiagnosis of malfunction of the reactant gas feed portion can be avoided.

Moreover, in the startup control process of Embodiment 1 described above, in the event of a determination that there is a malfunction of the reactant gas feed system, diagnosis of a generation malfunction of the fuel cell stack 100 will be disabled and measurement of open circuit voltage OCV of the fuel cell stack 100 will not take place. Accordingly, the reactant gas feeds can be halted without delay.

### B. Embodiment 2

### B1. Configuration of Fuel Cell System

The configuration of the fuel cell system of Embodiment 2 is substantially identical to the configuration of the fuel cell system 1000 of Embodiment 1. Accordingly, a description of the configuration of the fuel cell system of Embodiment 2 is omitted here. However, the startup control process in the fuel cell system of Embodiment 2 differs in part from the startup control process in the fuel cell system of Embodiment 1. The control unit and startup control process of Embodiment 2 will be described below.

### B2. Control Unit

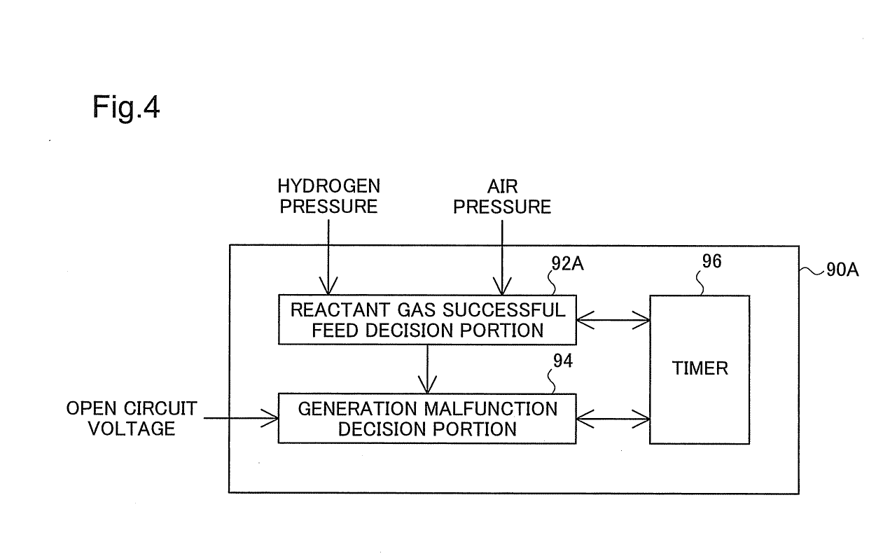

FIG. 4 is an illustration depicting function blocks in a control unit 90A for executing the startup control process of Embodiment 2. As illustrated, the control unit 90A is furnished with a reactant gas successful feed decision portion 92A, a generation malfunction decision portion 94, and a timer 96.

On the basis of whether the flow rate of hydrogen and the flow rate of air supplied to the fuel cell stack 100 and respectively sensed by a flow rate sensor FSh and a flow rate sensor FSa have respectively reached prescribed flow rates, the reactant gas successful feed decision portion 92A will decide whether hydrogen and air have been successfully fed to the fuel cell stack 100. The functions of the generation malfunction decision portion 94 and the timer 96 are the same as in Embodiment 1.

### B3. Startup Control Process

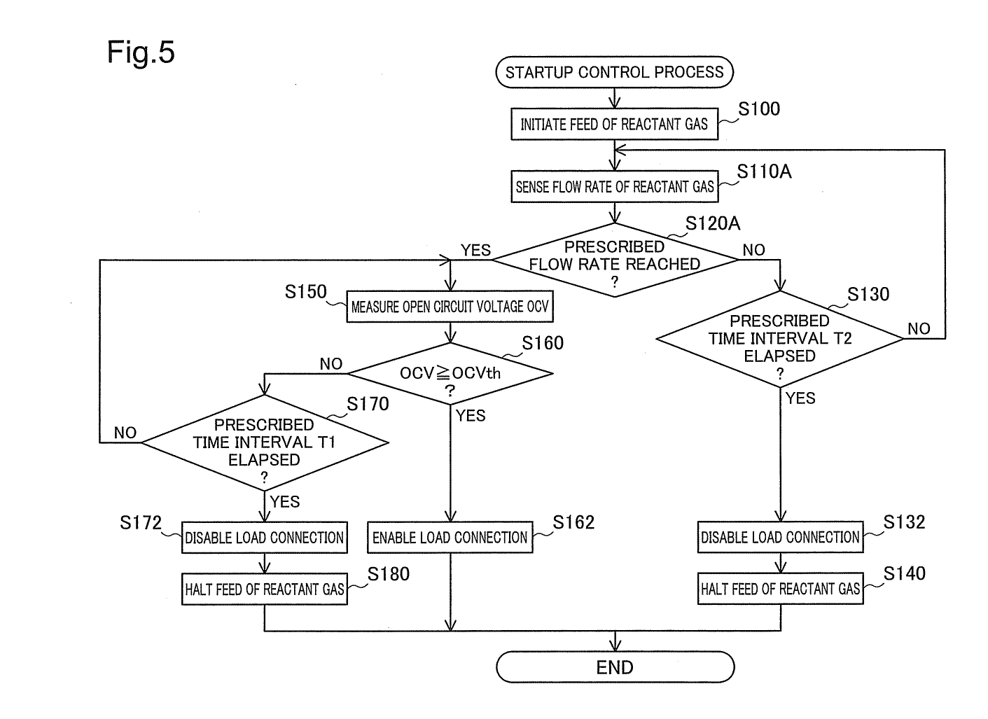

FIG. 5 is a flowchart depicting the flow of the startup control process of Embodiment 2. This process is one that is executed by the CPU of the control unit 90 when the fuel cell system 1000 is started up.

As will be appreciated from comparison of FIG. 3 with FIG. 5, in the startup control process of Embodiment 2, the processes of Step S100 and Steps S130 to S180 are the same as in the startup control process of Embodiment 1. Accordingly, description of these steps will be omitted here.

In the startup control process of Embodiment 2, following Step S100, through the flow rate sensors FSh and FSa the CPU will sense the flow rate of hydrogen and the flow rate of air respectively being supplied to the fuel cell stack 100 (Step S110A), and through the reactant gas successful feed decision portion 92A will then decide whether the flow rate of hydrogen and the flow rate of air have respectively reached prescribed flow rates (Step S120A). The prescribed flow rate of hydrogen and the prescribed flow rate of air have been established independently beforehand.

Then, if at least one of the flow rate of hydrogen and the flow rate of air which are supplied to the fuel cell stack 100 has failed to reach its corresponding prescribed flow rate (Step S120A: NO), the CPU 130 will advance to Step S130. If on the other hand the flow rate of hydrogen and the flow rate of air which are supplied to the fuel cell stack 100 have reached their corresponding prescribed flow rates (Step S120A: YES), the CPU 130 will advance to Step S150.

Like the fuel cell system 1000 of Embodiment 1, with the fuel cell system of Embodiment 2 described above, during the fuel cell system startup control process, once feed of the reactant gases to the fuel cell stack 100 has been successfully completed, the open circuit voltage OCV of the fuel cell stack 100 is measured, and on the basis of the measured open circuit voltage OCV it is decided whether the fuel cell is experiencing a generation malfunction stack 100. Accordingly, a generation malfunction in the fuel cell stack 100 can be correctly diagnosed during startup of the fuel cell system.

The open circuit voltage OCV of the fuel cell stack 100 is measured to after completing successful feed of reactant gases to the fuel cell stack 100. Accordingly, it is possible to distinguish between an instance in which open circuit voltage OCV of the fuel cell stack 100 has failed to rise to the prescribed voltage OCVth due to a malfunction in the reactant gas feed system, versus an instance in which open circuit voltage OCV of the fuel cell stack 100 has failed to rise to the prescribed voltage OCVth due to a malfunction in the fuel cell stack 100 itself, and thus to correctly diagnose a generation malfunction occurring in the fuel cell stack 100. Once a generation malfunction in the fuel cell stack 100 has been diagnosed, control in failsafe mode (in the present embodiment, halting the feed of reactant gases) can then be carried out.

Like the startup control process of Embodiment 1, in the startup control process of Embodiment 2 described above, a diagnosis of a generation malfunction in the fuel cell stack 100 will be made in the event that the open circuit voltage OCV of the fuel cell stack 100 fails to reach the prescribed voltage OCVth within the prescribed time interval T1 following the decision that successful feed of reactant gases to the fuel cell stack 100 has been completed. Accordingly, instances of misdiagnosis of generation malfunction in the fuel cell stack 100 can be avoided.

In the startup control process of Embodiment 2 described above, a diagnosis of a malfunction of the reactant gas feed system will be made in the event that the flow rates of the reactant gases fail to reach their respective prescribed pressures within the prescribed time interval T2 following initiation of fed of the reactant gases to the fuel cell stack 100. Accordingly, instances of misdiagnosis of malfunction in the reactant gas feed system can be avoided.

In the startup control process of Embodiment 2 described above, if a malfunction of the reactant gas feed system is determined to have occurred, diagnosis of a generation malfunction of the fuel cell stack 100 to will be disabled and measurement of open circuit voltage OCV of the fuel cell stack 100 will not take place. Accordingly, the reactant gas feeds can be halted without delay.

### C. Modified Embodiments

While the present invention has been shown herein through certain preferred embodiments, the invention is in no way limited by these embodiments and may be worked in various other modes without departing from the spirit thereof. Possible modifications include the following, for example.

### C1. Modified Embodiment 1

In Embodiment 1, the startup control process involves making the decision of successful completion of feed of reaction gases to the fuel cell stack 100 based on the hydrogen and air feed pressures, while in Embodiment 2 the startup control process involves making the decision of successful completion of feed of reaction gases to the fuel cell stack 100 based on the hydrogen and air feed flow rates; however, no limitation is imposed thereby, and these approaches could be appropriately combined.

### C2. Modified Embodiment 2

In Embodiment 1, in Step S120 of the startup control process shown in FIG. 3, the CPU of the control unit 90 will reset the timer 96 if the pressure of the hydrogen and the pressure of the air which are supplied to the fuel cell stack 100 have respectively reached prescribed pressure levels; however, the present invention is not limited to this arrangement. Specifically, instead of resetting the timer 96 if the pressure of the hydrogen and the pressure of the air supplied to the fuel cell stack 100 have respectively reached prescribed pressure levels in Step S120, elapsed time from initiation of feed of reaction gases of the fuel cell stack 100 could be measured continuously, and in Step S170, based on the elapsed time from initiation of feed of reaction gases of the fuel cell stack 100, a decision could be made to either return to Step S150 or advance to Step S172.

Analogously, in Embodiment 2, in Step S120A of the startup control process shown in FIG. 5, the CPU of the control unit 90A will reset the timer 96 if the flow rate of the hydrogen and the flow rate of the air which are supplied to the fuel cell stack 100 have respectively reached prescribed flow rates; however, the present invention is not limited to this arrangement. Specifically, instead of resetting the timer 96 if the flow rate of the hydrogen and the flow rate of the air supplied to the fuel cell stack 100 have respectively reached prescribed flow rates in Step S120A, elapsed time from initiation of feed of reaction gases of the fuel cell stack 100 could be measured continuously, and in Step S170, based on the elapsed time from initiation of feed of reaction gases of the fuel cell stack 100, a decision could be made to either return to Step S150 or advance to Step S172.

### C3. Modified Embodiment 3

According to the preceding embodiments, in the fuel cell system 1000 depicted in FIG. 1, the pressure sensor PSh and the flow rate sensor FSh are disposed on the hydrogen feed line 53, the pressure sensor PSa is disposed on the discharge line 62, and the flow rate sensor FSa is disposed on the air feed line 61; however, the present invention is not limited to this arrangement. The locations of the sensors may be established arbitrarily, provided that the locations enable sensing of the pressure and flow rate of the hydrogen and air flows fed to the fuel cell stack 100.

### C4. Modified Embodiment 4

In the preceding embodiments, the voltmeter 80 is designed to measure the open circuit voltage of the entire fuel cell stack 100; however, the present invention is not limited to this arrangement. For example, open circuit voltage could instead be measured for each individual fuel cell module 40. With such an arrangement, diagnosis of generation malfunction could be carried out individually for the plurality of fuel cell modules 40.

1. A fuel cell system comprising:
a fuel cell;
a reactant gas feed portion for supplying the fuel cell with reactant gases for power generation;
a reactant gas successful feed decision portion that at startup of the fuel cell system decides whether feed of the reactant gases to the fuel cell by the reactant gas feed portion was successfully completed; and
a generation malfunction diagnosis portion that, subsequent to a decision by the reactant gas successful feed decision portion that feeding of the reactant gases was successfully completed, determines whether the fuel cell is experiencing a generation malfunction, based on an open circuit voltage of the fuel cell,
wherein in the event that the open circuit voltage fails to reach prescribed pressure within a first prescribed time interval following a decision by the reactant gas successful feed decision portion that feed of the reactant gases to the fuel cell was successfully completed, the generation malfunction diagnosis portion determines that the fuel cell is experiencing a generation malfunction.

2. (canceled)

3. The fuel cell system according to claim 1 further comprising
a pressure sensor adapted to sense pressure of the reactant gases supplied to the fuel cell,
wherein the reactant gas successful feed decision portion makes the decision regarding whether the feed of the reactant gases to the fuel cell was successfully completed, based on pressure of the reactant gases sensed by the pressure sensor.

4. The fuel cell system according to claim 3 wherein
in the event that pressure of the reactant gases fails to reach prescribed pressure within a second prescribed time interval following initiation of feed of the reaction gases to the fuel cell by the reactant gas feed portion, the reactant gas successful feed decision portion further decides that the reactant gas feed portion is experiencing a malfunction.

5. The fuel cell system according to claim 1 further comprising
a flow rate sensor adapted to sense flow rate of the reactant gases being delivered to the fuel cell,
wherein the reactant gas successful feed decision portion makes the decision regarding whether the feed of the reactant gases to the fuel cell was successfully completed, based on flow rate of the reactant gases sensed by the flow rate sensor.

6. The fuel cell system according to claim 5 wherein
in the event that flow rate of the reactant gases fails to reach a prescribed flow rate within a second prescribed time interval following initiation of feed of the reaction gases to the fuel cell by the reactant gas feed portion, the reactant gas successful feed decision portion further decides that the reactant gas feed portion is experiencing a malfunction.

7. The fuel cell system according to claim 4 wherein
in the event of a decision by the reactant gas successful feed decision portion that the reactant gas feed portion is experiencing a malfunction, the generation malfunction diagnosis portion disables carrying out of the determination as to whether the fuel cell is experiencing the generation malfunction.

8. A method of controlling startup of a fuel cell system furnished with a fuel cell, comprising:
a reactant gas feed step in which the fuel cell is supplied with reactant gases for power generation;
a reactant gas successful feed decision step in which at startup of the fuel cell system, a decision is made regarding whether feed of the reactant gases to the fuel cell was successfully completed in the reactant gas feed step; and
a generation malfunction diagnosis step in which, subsequent to a decision in the reactant gas successful feed decision step that feeding of the reactant gases was successfully completed, a determination is made regarding whether the fuel cell is experiencing a generation malfunction, based on an open circuit voltage of the fuel cell,
wherein the generation malfunction diagnosis step includes a step of determining that the fuel cell is experiencing a generation malfunction in the event that the open circuit voltage fails to reach prescribed pressure within a first prescribed time interval following a decision in the reactant gas successful feed decision step that feed of the reactant gases to the fuel cell was successfully completed.
